(19) United States
(12) Patent Application Publication
(10) Pub. No.: US 2013/0252870 A1
(43) Pub. Date: Sep. 26, 2013

(54) CLEANING COMPOSITION INCLUDING A TERPOLYMER CONTAINING MALEIC ACID, VINYL ACETATE, AND ALKYL ACRYLATE MONOMERS FOR ENHANCED SCALE CONTROL

(71) Applicant: Carter Silvernail, Burnsville, MN (US)

(72) Inventor: Carter Silvernail, Burnsville, MN (US)

(73) Assignee: ECOLAB USA INC., St. Paul, MN (US)

(21) Appl. No.: 13/428,643

(22) Filed: Mar. 23, 2012

(51) Int. Cl. C11D 3/60; C11D 17/00; C11D 7/60

(52) U.S. Cl. 510/180; 510/476; 510/446; 510/445; 510/434; 510/403; 510/404; 510/245; 510/238; 510/244

(57) ABSTRACT

The present invention is related to a cleaning composition including at least one alkalinity source and a biodegradable terpolymer including maleic acid, vinyl acetate and alkyl acrylate segments or monomers for controlling scale. The diluted use solution has a pH between about 7 and about 11.5.

### CROSS REFERENCE TO RELATED APPLICATIONS

This application is related to U.S. application No. ______, (Attorney Docket No. 2878US01) entitled “TERPOLYMER CONTAINING MALEIC ACID, VINYL ACETATE, AND ALKYL ACRYLATE MONOMERS FOR ALUMINUM PROTECTION,” U.S. application No. ______, (Attorney Docket No. 2964US01) entitled “A METHOD FOR Reduced encrustation OF TEXTILES USING A POLYMER COMPRISING MALEIC ACID, VINYL ACETATE, AND ALKYL ACRYLATE,” and to U.S. application No. ______, (Attorney Docket No. 2868US01) entitled “A CLEANING COMPOSITION INCLUDING A TERPOLYMER CONTAINING MALEIC ACID, VINYL ACETATE, AND ALKYL ACRYLATE MONOMERS FOR ENHANCED SCALE CONTROL,” which were filed concurrently herewith. The entire contents of these patent applications are hereby expressly incorporated herein by reference including without limitation, the specification, claims, and abstract, as well as any figures, tables or drawings thereof.

### TECHNICAL FIELD

The present invention is related to a cleaning composition including at least one alkalinity source and a polymer including maleic acid, vinyl acetate and alkyl acrylate segments or monomers for controlling scale.

### BACKGROUND

Conventional cleanings used in the vehicle care, warewashing and laundry industries include alkaline cleanings Alkaline cleanings, particularly those intended for institutional and commercial use, in combination with the presence of hard water commonly results in heavy scale formation that is difficult to control, particularly in warewash applications at elevated temperatures. Alkaline cleanings often contain polymers, phosphonates, phosphates, chelating agents such as nitrilotriacetic acid (NTA) and ethylenediaminetetraacetic acid (EDTA) to help control scale, remove soils, and/or sequester metal ions such as calcium, magnesium and iron.

Chelating agents and/or threshold agents are often used in alkaline cleanings because of their ability to solubilize metal salts and/or prevent calcium, magnesium and iron salts from precipitating. When calcium, magnesium and iron salts precipitate, the crystals may attach to the surface being cleaned and cause undesirable effects. For example, calcium carbonate precipitation on the surface of ware can negatively impact the aesthetic appearance of the ware, giving an unclean look.

### SUMMARY

The present invention includes a cleaning composition for removing soils and preventing hard water scale accumulation. The cleaning composition includes at least an alkalinity source, and a polymer comprising maleic acid, vinyl acetate and alkyl acrylate monomers.

In one embodiment, the present invention is a cleaning composition including an alkalinity source in an amount between approximately 10% and approximately 90% by weight and a polymer containing maleic acid, vinyl acetate and alkyl acrylate monomers in an amount greater than or equal to approximately 0.1% by weight. The diluted use cleaning solution has a pH between about 7 and about 11.5.

In yet another embodiment, the cleaning composition is used in a method to prevent scale formation, accumulation and/or adhesion during a wash cycle. The polymer containing maleic acid, vinyl acetate and alkyl acrylate monomers are mixed with an alkalinity source and a surfactant system to form a cleaning composition. The cleaning composition is then diluted at a dilution ratio of between about 1:10 and about 1:10,000 to form a use solution. The use solution is then contacted with a substrate to be cleaned. The temperature of the wash cycle is between about 70 degrees and 150 degrees Fahrenheit.

While multiple embodiments are disclosed, still other embodiments of the present invention will become apparent to those skilled in the art from the following detailed description, which shows and describes illustrative embodiments of the invention. Accordingly, the detailed description is to be regarded as illustrative in nature and not restrictive.

### DETAILED DESCRIPTION

The present invention provides a cleaning composition with an alkalinity source and a polymer including maleic acid, vinyl acetate and alkyl acrylate monomers. Such composition may be particularly useful in reducing and/or inhibiting scale formation, precipitation and/or substrate adhesion in hard water and may be used in a solid block form. Further, such compositions can be biodegradable and substantially free of phosphorus containing components to comply with various regulatory requirements.

The cleaning composition can be applied in any environment where it is desirable to remove soils, solubilize metal salts and prevent the precipitation of magnesium, calcium and/or iron salts. For example, the cleaning composition can be used in vehicle care applications, warewashing applications, healthcare applications, laundering applications and food and beverage applications. Such applications include, but are not limited to: machine and manual warewashing, presoaks, laundry and textile cleaning and destaining, carpet cleaning and destaining, vehicle cleaning and care applications, surface cleaning and destaining, kitchen and bath cleaning and destaining, floor cleaning and destaining, medical instrument cleaning and destaining, cleaning in place operations, general purpose cleaning and destaining, and industrial or household cleaners. Methods of using the cleaning composition including the polymer containing maleic acid, vinyl acetate and alkyl acrylate monomers are also provided.

The cleaning composition generally includes an alkalinity source and a polymer including maleic acid, vinyl acetate and alkyl acrylate monomers or segments. The cleaning composition can include an effective amount of alkalinity to enhance cleaning of the desired substrate and improve soil removal performance of the composition. An effective amount of the alkalinity source may provide a use composition (i.e., an aqueous solution containing the composition) having a pH of between about 7 and about 11.5.

A suitable concentration range of the components in the cleaning composition include between approximately 10% and approximately 90% by weight of the alkalinity source, and greater than or equal to approximately 0.1% by weight of the polymer containing maleic acid, vinyl acetate and alkyl acrylate monomers. A particularly suitable concentration range of the components in the cleaning composition include between approximately 15% and approximately 90% by weight of the alkalinity source, and between approximately 0.15 and approximately 20% by weight of the polymer containing maleic acid, vinyl acetate and alkyl acrylate monomers. A more particularly suitable concentration range of the components in the cleaning composition include between approximately 20% and approximately 70% by weight of the alkalinity source, and between approximately 1% and 15% by weight of the polymer containing maleic acid, vinyl acetate and alkyl acrylate monomers.

An alkalinity source can be present in an effective amount to enhance cleaning of the desired substrate and can provide a use composition having a pH of at least about 7. A suitable concentration range for the components of this cleaning composition include between approximately 10% and approximately 90% by weight of the alkalinity source and between approximately 0.1% and 20% by weight of the polymer containing maleic acid, vinyl acetate and alkyl acrylate monomers. A particularly suitable concentration range of the components in the cleaning composition include between approximately 20% and approximately 70% by weight of the alkalinity source and between approximately 1% and 15% by weight of the polymer containing maleic acid, vinyl acetate and alkyl acrylate monomers.

Examples of suitable alkalinity sources of the cleaning composition include, but are not limited to alkali metal carbonates, alkali metal hydroxides and alkali metal silicates. Exemplary alkali metal carbonates that can be used include, but are not limited to: sodium or potassium carbonate, bicarbonate, sesquicarbonate, and mixtures thereof. Exemplary alkali metal hydroxides that can be used include, but are not limited to: sodium or potassium hydroxide. The alkali metal hydroxide may be added to the composition in any form known in the art, including as solid beads, dissolved in an aqueous solution, or a combination thereof. Examples of alkali metal silicates include, but are not limited to sodium or potassium silicate or polysilicate, sodium or potassium metasilicate and hydrated sodium or potassium metasilicate or a combination thereof.

The alkalinity source controls the pH of the resulting solution when water is added to the cleaning composition to form a use solution. The pH of the use solution must be maintained in the alkaline range in order to provide sufficient detergency properties. In one embodiment, the pH of the use solution is between approximately 7 and approximately 11.5. If the pH of the use solution is too low, for example, below approximately 7, the use solution may not provide adequate detergency properties. If the pH of the use solution is too high, for example, above approximately 11.5, the use solution may be too alkaline and attack or damage the surface to be cleaned.

The alkalinity source may also function as a hydratable salt to form the solid cast. The hydratable salt can be referred to as substantially anhydrous. By substantially anhydrous, it is meant that the component contains less than about 2% by weight water based upon the weight of the hydratable component. The amount of water can be less than about 1% by weight, and can be less than about 0.5% by weight. There is no requirement that the hydratable component be completely anhydrous.

The cleaning composition also includes water of hydration to hydrate the alkalinity source/hydratable salt. It should be understood that the reference to water includes water of hydration and free water. The phrase “water of hydration” refers to water which is somehow attractively bound to a non-water molecule. An exemplary form of attraction includes hydrogen bonding. In addition to hydrating the hydratable salt, the water of hydration also functions to increase the viscosity of the mixture during processing and cooling to prevent separation of the components. The amount of water of hydration in the cleaning composition will depend on the alkalinity source/hydratable salt.

The cleaning composition further includes a polymer containing maleic acid, alkyl acrylate and vinyl acetate monomers, which may function as a scale inhibitor in the use composition. The maleic acid, alkyl acrylate and vinyl acetate polymer may include one or more alkyl acrylate monomers. Suitable alkyl acrylate monomers include methyl acrylate, ethyl acrylate, propyl acrylate, butyl acrylate, isopropyl acrylate and tert-butyl acrylate.

In one example, the polymer is a terpolymer containing maleic acid, alkyl acrylate and vinyl acetate monomers. A suitable maleic acid, alkyl acrylate and vinyl acetate terpolymer has a molecular weight between about 500 g/mol and about 5,000 g/mol. A more suitable maleic acid, alkyl acrylate and vinyl acetate terpolymer has a molecular weight between about 500 g/mol and about 3,000 g/mol. The polymer may comprise between about 40% and about 99% by weight maleic acid, between about 1% and about 50% by weight vinyl acetate and between about 1% and about 50% by weight alkyl acrylate. In a specific example the terpolymer may comprise between about 40% and about 99% by weight maleic acid, between about 1% and about 50% by weight vinyl acetate and between about 1% and about 50% by weight ethyl acrylate.

The maleic acid, alkyl acrylate and vinyl acetate polymer can be biodegradable. A suitable maleic acid, alkyl acrylate and vinyl acetate terpolymer can be at least about 15% biodegradable. A particularly suitable maleic acid, alkyl acrylate and vinyl acetate terpolymer can be between about 15% and 60% biodegradable after 35 days using the test protocol of OECD 302B. Example commercially available maleic acid, alkyl acrylate and vinyl acetate terpolymers include Belclene® 283 and Belclene® 810 both available from BWA, Tucker, Ga.

The alkyl acrylate and vinyl acetate monomers may hydrolyze in the concentrate or in the use composition. For example, at alkaline pH the alkyl acrylate and/or vinyl acetate segments can hydrolyze to carboxylic acids. As used herein, reference to an alkyl acrylate and/or vinyl acetate monomer includes all hydrolyzed forms of such monomer. The vinyl acetate and/or alkyl acrylate segments may be partially or completely hydrolyzed. In one example the polymer may include at least one hydrolyzed vinyl acetate or alkyl acrylate monomer. Additionally, as used herein, reference to maleic acid monomers include monomers of maleic acid and salts thereof.

The cleaning composition can be phosphorus-free and/or nitrilotriacetic acid (NTA)-free to make the cleaning composition more environmentally beneficial. Phosphorus-free means a composition having less than approximately 0.5%, more particularly less than approximately 0.1 wt %, and even more particularly less than approximately 0.01 wt % phosphorus based on the total weight of the composition. NTA-free means a composition having less than approximately 0.5 wt %, less than approximately 0.1 wt %, and particularly less than approximately 0.01 wt % NTA based on the total weight of the composition. When the composition is NTA-free, it is also compatible with chlorine, which functions as an anti-redeposition and stain-removal agent.

### Additional Functional Materials

The cleaning composition can also include various additional functional components. In some embodiments, the alkalinity source, a surfactant, and the maleic acid, alkyl acrylate and vinyl acetate polymer make up a large amount, or even substantially all of the total weight of the cleaning composition, for example, in embodiments having few or no additional functional materials disposed therein. In one specific example, the cleaning composition consists essentially of a surfactant, an alkalinity source that includes an alkali metal carbonate and a maleic acid, vinyl acetate and alkyl acrylate terpolymer. In another specific example, the cleaning composition consists essentially of a surfactant, an alkalinity source that includes an alkali metal carbonate and a maleic acid, vinyl acetate and ethyl acrylate terpolymer. In these embodiments, the component concentration ranges provided above for the composition are representative of the ranges of those same components in the cleaning composition.

In alternative embodiments, functional materials are added to provide desired properties and functionalities to the cleaning composition. For the purpose of this application, the term “functional materials” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional materials may be used. Moreover, the components discussed above may be multi-functional and may also provide several of the functional benefits discussed below.

Secondary Polymer

In one embodiment, the cleaning composition includes one or more secondary polymer(s) in addition to the alkalinity source and the terpolymer containing maleic acid, alkyl acrylate and vinyl acetate monomers. Polymers, comprise of the terpolymer containing maleic acid, alkyl acrylate and vinyl acetate monomers and the secondary polymer, can be present in an effective amount to enhance scale control of the desired substrate. A suitable concentration range for the components of this cleaning composition include between approximately 0.1% and 20% by weight of the polymer containing maleic acid, vinyl acetate and alkyl acrylate monomers, between approximately 0.1% and 20% by weight of a secondary polymer, and between approximately 10% and 90% by weight of the alkalinity source. A particularly suitable concentration range of the components in the cleaning composition include between approximately 0.1% and 15% by weight of the polymer containing maleic acid, vinyl acetate and alkyl acrylate monomers, between approximately 0.1% and 15% by weight of a secondary polymer, and between approximately 20% and 70% by weight of the alkalinity source.

Examples of suitable secondary polymer sources of the cleaning composition include, but are not limited to polycarboxylic acid, polyacrylic acid, polymethacrylic acid, polymaleic acid homopolymers, copolymer of acrylic acid, copolymer of methacrylic acid, copolymer of maleic acid, acrylic acid, methacrylic acid, maleic acid terpolymers, or combinations thereof.

Surfactants

The cleaning composition may also include a surfactant. A variety of surfactants can be used in the cleaning composition, including, but not limited to: anionic, nonionic, cationic, and zwitterionic surfactants. Exemplary surfactants that can be used are commercially available from a number of sources. For a discussion of surfactants, see Kirk-Othmer, Encyclopedia of Chemical Technology, Third Edition, volume 8, pages 900-912. When the cleaning composition includes a surfactant as a cleaning agent, the cleaning agent is provided in an amount effective to provide a desired level of cleaning. The cleaning composition, when provided as a concentrate, can include the surfactant cleaning agent in a range of about 0.05% to about 20% by weight, about 0.5% to about 15% by weight, about 1% to about 15% by weight, about 1.5% to about 10% by weight, and about 2% to about 8% by weight. Additional exemplary ranges of surfactant in a concentrate include about 0.5% to about 8% by weight, and about 1% to about 5% by weight.

Examples of anionic surfactants useful in the cleaning composition include, but are not limited to: carboxylates such as alkylcarboxylates and polyalkoxycarboxylates, alcohol ethoxylate carboxylates, nonylphenol ethoxylate carboxylates; sulfonates such as alkylsulfonates, alkylbenzenesulfonates, alkylarylsulfonates, sulfonated fatty acid esters; sulfates such as sulfated alcohols, sulfated alcohol ethoxylates, sulfated alkylphenols, alkylsulfates, sulfosuccinates, and alkylether sulfates. Exemplary anionic surfactants include, but are not limited to: sodium alkylarylsulfonate, alpha-olefinsulfonate, and fatty alcohol sulfates.

Examples of nonionic surfactants useful in the cleaning composition include, but are not limited to, those having a polyalkylene oxide polymer as a portion of the surfactant molecule. Such nonionic surfactants include, but are not limited to: chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated amines such as alkoxylated ethylene diamine; alcohol alkoxylates such as alcohol ethoxylate propoxylates, alcohol propoxylates, alcohol propoxylate ethoxylate propoxylates, alcohol ethoxylate butoxylates; nonylphenol ethoxylate, polyoxyethylene glycol ether; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and polyalkylene oxide block polymers. An example of a commercially available ethylene oxide/propylene oxide block polymer includes, but is not limited to, PLURONIC®, available from BASF Corporation, Florham Park, N.J. An example of a commercially available silicone surfactant includes, but is not limited to, ABIL® B8852, available from Goldschmidt Chemical Corporation, Hopewell, Va. A particularly suitable surfactant is D500, an ethylene oxide/propylene oxide polymer available from BASF Corporation, Florham Park, N.J.

Examples of cationic surfactants that can be used in the cleaning composition include, but are not limited to: amines such as primary, secondary and tertiary monoamines with C₁₈ alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C₁₂-C₁₈)dimethylbenzyl ammonium chloride, n-tetradecyldimethylbenzylammonium chloride monohydrate, and a naphthylene-substituted quaternary ammonium chloride such as dimethyl-1-naphthylmethylammonium chloride. The cationic surfactant can be used to provide sanitizing properties.

Examples of zwitterionic surfactants that can be used in the cleaning composition include, but are not limited to: betaines, imidazolines, and propionates.

When the cleaning composition is intended to be used in an automatic dishwashing or warewashing machine, the surfactants selected, if any surfactant is used, can be those that provide an acceptable level of foaming when used inside a dishwashing or warewashing machine. Cleaning compositions for use in automatic dishwashing or warewashing machines are generally considered to be low-foaming compositions. Low foaming surfactants that provide the desired level of detersive activity are advantageous in an environment such as a dishwashing machine where the presence of large amounts of foaming can be problematic. In addition to selecting low foaming surfactants, defoaming agents can also be utilized to reduce the generation of foam. Accordingly, surfactants that are considered low foaming surfactants can be used. In addition, other surfactants can be used in conjunction with a defoaming agent to control the level of foaming.

Builders or Water Conditioners

The cleaning composition can include one or more building agents, also called chelating or sequestering agents (e.g., builders), including, but not limited to: condensed phosphates, alkali metal carbonates, phosphonates, aminocarboxylic acids, and/or polyacrylates. In general, a chelating agent is a molecule capable of coordinating (i.e., binding) the metal ions commonly found in natural water to prevent the metal ions from interfering with the action of the other detersive ingredients of a cleaning composition. Preferable levels of addition for builders that can also be chelating or sequestering agents are between about 0.1% to about 70% by weight, about 1% to about 60% by weight, or about 1.5% to about 50% by weight. If the solid cleaning is provided as a concentrate, the concentrate can include between approximately 1% to approximately 60% by weight, between approximately 3% to approximately 50% by weight, and between approximately 6% to approximately 45% by weight of the builders. Additional ranges of the builders include between approximately 3% to approximately 20% by weight, between approximately 6% to approximately 15% by weight, between approximately 25% to approximately 50% by weight, and between approximately 35% to approximately 45% by weight.

Examples of condensed phosphates include, but are not limited to: sodium and potassium orthophosphate, sodium and potassium pyrophosphate, sodium tripolyphosphate, and sodium hexametaphosphate. A condensed phosphate may also assist, to a limited extent, in solidification of the cleaning composition by fixing the free water present in the composition as water of hydration.

Examples of phosphonates include, but are not limited to: 2-phosphonobutane-1,2,4-tricarboxylic acid (PBTC), 1-hydroxyethane-1,1-diphosphonic acid, CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₍₂₈₋ₓ₎N₃NaₓO₁₅P₅ (x=7); hexamethylenediamine(tetramethylenephosphonate), potassium salt, C₁₀H₍₂₈₋ₓ₎N₂KₓO₁₂P₄ (x=6); bis(hexamethylene)triamine(pentamethylenephosphonic acid), (HO₂)POCH₂N[(CH₂)₂N[CH₂PO(OH)₂]₂]₂; and phosphorus acid, H₃PO₃. A preferred phosphonate combination is ATMP and DTPMP. A neutralized or alkali phosphonate, or a combination of the phosphonate with an alkali source prior to being added into the mixture such that there is little or no heat or gas generated by a neutralization reaction when the phosphonate is added is preferred. In one embodiment, however, the cleaning composition is phosphorous-free.

Useful aminocarboxylic acid materials containing little or no NTA include, but are not limited to: N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), methylglycinediacetic acid (MGDA), glutamic acid-N,N-diacetic acid (GLDA), ethylenediaminesuccinic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent. In one embodiment, however, the composition is free of aminocarboxylates.

Water conditioning polymers can be used as non-phosphorus containing builders. Exemplary water conditioning polymers include, but are not limited to: polycarboxylates. Exemplary polycarboxylates that can be used as builders and/or water conditioning polymers include, but are not limited to: those having pendant carboxylate (—CO₂⁻) groups such as polyacrylic acid, maleic acid, maleic/olefin polymer, sulfonated polymer or terpolymer, acrylic/maleic polymer, polymethacrylic acid, acrylic acid-methacrylic acid polymers, hydrolyzed polyacrylamide, hydrolyzed polymethacrylamide, hydrolyzed polyamide-methacrylamide polymers, hydrolyzed polyacrylonitrile, hydrolyzed polymethacrylonitrile, and hydrolyzed acrylonitrile-methacrylonitrile polymers. Other suitable water conditioning polymers include starch, sugar or polyols comprising carboxylic acid or ester functional groups. Exemplary carboxylic acids include but are not limited to maleic acid, acrylic, methacrylic and itaconic acid or salts thereof. Exemplary ester functional groups include aryl, cyclic, aromatic and C₁-C₁₀ linear, branched or substituted esters. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These materials may also be used at substoichiometric levels to function as crystal modifiers

Hardening Agents

The cleaning compositions can also include a hardening agent in addition to, or in the form of, the builder. A hardening agent is a compound or system of compounds, organic or inorganic, which significantly contributes to the uniform solidification of the composition. Preferably, the hardening agents are compatible with the cleaning agent and other active ingredients of the composition and are capable of providing an effective amount of hardness and/or aqueous solubility to the processed composition. The hardening agents should also be capable of forming a homogeneous matrix with the cleaning agent and other ingredients when mixed and solidified to provide a uniform dissolution of the cleaning agent from the cleaning composition during use.

The amount of hardening agent included in the cleaning composition will vary according to factors including, but not limited to: the type of cleaning composition being prepared, the ingredients of the cleaning composition, the intended use of the composition, the quantity of dispensing solution applied to the solid composition over time during use, the temperature of the dispensing solution, the hardness of the dispensing solution, the physical size of the cleaning composition, the concentration of the other ingredients, and the concentration of the cleaning agent in the composition. It is preferred that the amount of the hardening agent included in the cleaning composition is effective to combine with the cleaning agent and other ingredients of the composition to form a homogeneous mixture under continuous mixing conditions and a temperature at or below the melting temperature of the hardening agent.

It is also preferred that the hardening agent form a matrix with the cleaning agent and other ingredients which will harden to a solid form under ambient temperatures of approximately 30° C. to approximately 50° C., particularly approximately 35° C. to approximately 45° C., after mixing ceases and the mixture is dispensed from the mixing system, within approximately 1 minute to approximately 3 hours, particularly approximately 2 minutes to approximately 2 hours, and particularly approximately 5 minutes to approximately 1 hour. A minimal amount of heat from an external source may be applied to the mixture to facilitate processing of the mixture. It is preferred that the amount of the hardening agent included in the cleaning composition is effective to provide a desired hardness and desired rate of controlled solubility of the processed composition when placed in an aqueous medium to achieve a desired rate of dispensing the cleaning agent from the solidified composition during use.

The hardening agent may be an organic or an inorganic hardening agent. A preferred organic hardening agent is a polyethylene glycol (PEG) compound. The solidification rate of cleaning compositions comprising a polyethylene glycol hardening agent will vary, at least in part, according to the amount and the molecular weight of the polyethylene glycol added to the composition. Examples of suitable polyethylene glycols include, but are not limited to: solid polyethylene glycols of the general formula H(OCH₂CH₂)ₙOH, where n is greater than 15, particularly approximately 30 to approximately 1700. Typically, the polyethylene glycol is a solid in the form of a free-flowing powder or flakes, having a molecular weight of approximately 1,000 to approximately 100,000, particularly having a molecular weight of at least approximately 1,450 to approximately 20,000, more particularly between approximately 1,450 to approximately 8,000. The polyethylene glycol is present at a concentration of from approximately 1% to 75% by weight and particularly approximately 3% to approximately 15% by weight. Suitable polyethylene glycol compounds include, but are not limited to: PEG 4000, PEG 1450, and PEG 8000 among others, with PEG 4000 and PEG 8000 being most preferred. An example of a commercially available solid polyethylene glycol includes, but is not limited to: CARBOWAX, available from Union Carbide Corporation, Houston, Tex.

Preferred inorganic hardening agents are hydratable inorganic salts, including, but not limited to: sulfates and bicarbonates. The inorganic hardening agents are present at concentrations of up to approximately 50% by weight, particularly approximately 5% to approximately 25% by weight, and more particularly approximately 5% to approximately 15% by weight. In one embodiment, however, the solid composition if free of sulfates and carbonates including soda ash.

Urea particles can also be employed as hardeners in the cleaning compositions. The solidification rate of the compositions will vary, at least in part, to factors including, but not limited to: the amount, the particle size, and the shape of the urea added to the composition. For example, a particulate form of urea can be combined with a cleaning agent and other ingredients, and preferably a minor but effective amount of water. The amount and particle size of the urea is effective to combine with the cleaning agent and other ingredients to form a homogeneous mixture without the application of heat from an external source to melt the urea and other ingredients to a molten stage. It is preferred that the amount of urea included in the cleaning composition is effective to provide a desired hardness and desired rate of solubility of the composition when placed in an aqueous medium to achieve a desired rate of dispensing the cleaning agent from the solidified composition during use. In some embodiments, the composition includes between approximately 5% to approximately 90% by weight urea, particularly between approximately 8% and approximately 40% by weight urea, and more particularly between approximately 10% and approximately 30% by weight urea.

The urea may be in the form of prilled beads or powder. Prilled urea is generally available from commercial sources as a mixture of particle sizes ranging from about 8-15 U.S. mesh, as for example, from Arcadian Sohio Company, Nitrogen Chemicals Division. A prilled form of urea is preferably milled to reduce the particle size to about 50 U.S. mesh to about 125 U.S. mesh, particularly about 75-100 U.S. mesh, preferably using a wet mill such as a single or twin-screw extruder, a Teledyne mixer, a Ross emulsifier, and the like.

Bleaching Agents

Bleaching agents suitable for use in the cleaning composition for lightening or whitening a substrate include bleaching compounds capable of liberating an active halogen species, such as Cl₂, Br₂, —OCl⁻ and/or —OBr⁻, under conditions typically encountered during the cleansing process. Suitable bleaching agents for use in the cleaning compositions include, but are not limited to: chlorine-containing compounds such as chlorine, hypochlorites, or chloramines. Exemplary halogen-releasing compounds include, but are not limited to: the alkali metal dichloroisocyanurates, chlorinated trisodium phosphate, the alkali metal hypochlorites, monochloramine, and dichloramine. Encapsulated chlorine sources may also be used to enhance the stability of the chlorine source in the composition (see, for example, U.S. Pat. Nos. 4,618,914 and 4,830,773, the disclosure of which is incorporated by reference herein). A bleaching agent may also be a peroxygen or active oxygen source such as hydrogen peroxide, perborates, sodium carbonate peroxyhydrate, potassium permonosulfate, and sodium perborate mono and tetrahydrate, with and without activators such as tetraacetylethylene diamine. When the concentrate includes a bleaching agent, it can be included in an amount of between approximately 0.1% and approximately 60% by weight, between approximately 1% and approximately 20% by weight, between approximately 3% and approximately 8% by weight, and between approximately 3% and approximately 6% by weight.

Fillers

The cleaning composition can include an effective amount of cleaning fillers which do not perform as a cleaning agent per se, but cooperates with the cleaning agent to enhance the overall cleaning capacity of the composition. Examples of cleaning fillers suitable for use in the present cleaning compositions include, but are not limited to: sodium sulfate and sodium chloride. When the concentrate includes a cleaning filler, it can be included in an amount up to approximately 50% by weight, between approximately 1% and approximately 30% by weight, or between approximately 1.5% and approximately 25% by weight.

Defoaming Agents

A defoaming agent for reducing the stability of foam may also be included in the cleaning composition. Examples of defoaming agents include, but are not limited to: ethylene oxide/propylene block polymers such as those available under the name Pluronic® N-3 available from BASF Corporation, Florham Park, N.J.; silicone compounds such as silica dispersed in polydimethylsiloxane, polydimethylsiloxane, and functionalized polydimethylsiloxane such as those available under the name Abil® B9952 available from Goldschmidt Chemical Corporation, Hopewell, Va.; fatty amides, hydrocarbon waxes, fatty acids, fatty esters, fatty alcohols, fatty acid soaps, ethoxylates, mineral oils, polyethylene glycol esters, and alkyl phosphate esters such as monostearyl phosphate. A discussion of defoaming agents may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated herein by reference. When the concentrate includes a defoaming agent, the defoaming agent can be provided in an amount of between approximately 0.0001% and approximately 10% by weight, between approximately 0.001% and approximately 5% by weight, or between approximately 0.01% and approximately 1.0% by weight.

Anti-Redeposition Agents

The cleaning composition can include an anti-redeposition agent for facilitating sustained suspension of soils in a cleaning solution and preventing the removed soils from being redeposited onto the substrate being cleaned. Examples of suitable anti-redeposition agents include, but are not limited to: polyacrylates, styrene maleic anhydride polymers, cellulosic derivatives such as hydroxyethyl cellulose, hydroxypropyl cellulose and carboxymethyl cellulose. When the concentrate includes an anti-redeposition agent, the anti-redeposition agent can be included in an amount of between approximately 0.5% and approximately 10% by weight, and between approximately 1% and approximately 5% by weight.

Stabilizing Agents

The cleaning composition may also include stabilizing agents. Examples of suitable stabilizing agents include, but are not limited to: borate, calcium/magnesium ions, propylene glycol, and mixtures thereof. The concentrate need not include a stabilizing agent, but when the concentrate includes a stabilizing agent, it can be included in an amount that provides the desired level of stability of the concentrate. Exemplary ranges of the stabilizing agent include up to approximately 20% by weight, between approximately 0.5% and approximately 15% by weight, and between approximately 2% and approximately 10% by weight.

Dispersants

The cleaning composition may also include dispersants. Examples of suitable dispersants that can be used in the cleaning composition include, but are not limited to: maleic acid/olefin polymers, polyacrylic acid, and mixtures thereof. The concentrate need not include a dispersant, but when a dispersant is included it can be included in an amount that provides the desired dispersant properties. Exemplary ranges of the dispersant in the concentrate can be up to approximately 20% by weight, between approximately 0.5% and approximately 15% by weight, and between approximately 2% and approximately 9% by weight.

Enzymes

Enzymes that can be included in the cleaning composition include those enzymes that aid in the removal of starch and/or protein stains. Exemplary types of enzymes include, but are not limited to: proteases, alpha-amylases, and mixtures thereof. Exemplary proteases that can be used include, but are not limited to: those derived from Bacillus licheniformix, Bacillus lenus, Bacillus alcalophilus, and Bacillus amyloliquefacins. Exemplary alpha-amylases include Bacillus subtilis, Bacillus amyloliquefaciens and Bacillus licheniformis. The concentrate need not include an enzyme, but when the concentrate includes an enzyme, it can be included in an amount that provides the desired enzymatic activity when the cleaning composition is provided as a use composition. Exemplary ranges of the enzyme in the concentrate include up to approximately 15% by weight, between approximately 0.5% to approximately 10% by weight, and between approximately 1% to approximately 5% by weight.

Fragrances and Dyes

Various dyes, odorants including perfumes, and other aesthetic enhancing agents can also be included in the composition. Suitable dyes that may be included to alter the appearance of the composition, include, but are not limited to: Direct Blue 86, available from Mac Dye-Chem Industries, Ahmedabad, India; Fastusol Blue, available from Mobay Chemical Corporation, Pittsburgh, Pa.; Acid Orange 7, available from American Cyanamid Company, Wayne, N.J.; Basic Violet 10 and Sandolan Blue/Acid Blue 182, available from Sandoz, Princeton, N.J.; Acid Yellow 23, available from Chemos GmbH, Regenstauf, Germany; Acid Yellow 17, available from Sigma Chemical, St. Louis, Mo.; Sap Green and Metanil Yellow, available from Keyston Analine and Chemical, Chicago, Ill.; Acid Blue 9, available from Emerald Hilton Davis, LLC, Cincinnati, Ohio; Hisol Fast Red and Fluorescein, available from Capitol Color and Chemical Company, Newark, N.J.; and Acid Green 25, Ciba Specialty Chemicals Corporation, Greenboro, N.C.

Fragrances or perfumes that may be included in the compositions include, but are not limited to: terpenoids such as citronellol, aldehydes such as amyl cinnamaldehyde, a jasmine such as C1S-jasmine or jasmal, and vanillin.

Thickeners

The cleaning compositions can include a rheology modifier or a thickener. The rheology modifier may provide the following functions: increasing the viscosity of the compositions; increasing the particle size of liquid use compositions when dispensed through a spray nozzle; providing the use compositions with vertical cling to surfaces; providing particle suspension within the use compositions; or reducing the evaporation rate of the use compositions.

The rheology modifier may provide a use composition that is pseudo plastic, in other words the use composition or material when left undisturbed (in a shear mode), retains a high viscosity. However, when sheared, the viscosity of the material is substantially but reversibly reduced. After the shear action is removed, the viscosity returns. These properties permit the application of the material through a spray head. When sprayed through a nozzle, the material undergoes shear as it is drawn up a feed tube into a spray head under the influence of pressure and is sheared by the action of a pump in a pump action sprayer. In either case, the viscosity can drop to a point such that substantial quantities of the material can be applied using the spray devices used to apply the material to a soiled surface. However, once the material comes to rest on a soiled surface, the materials can regain high viscosity to ensure that the material remains in place on the soil. Preferably, the material can be applied to a surface resulting in a substantial coating of the material that provides the cleaning components in sufficient concentration to result in lifting and removal of the hardened or baked-on soil. While in contact with the soil on vertical or inclined surfaces, the thickeners in conjunction with the other components of the cleaner minimize dripping, sagging, slumping or other movement of the material under the effects of gravity. The material should be formulated such that the viscosity of the material is adequate to maintain contact between substantial quantities of the film of the material with the soil for at least a minute, particularly five minutes or more.

Examples of suitable thickeners or rheology modifiers are polymeric thickeners including, but not limited to: polymers or natural polymers or gums derived from plant or animal sources. Such materials may be polysaccharides such as large polysaccharide molecules having substantial thickening capacity. Thickeners or rheology modifiers also include clays.

A substantially soluble polymeric thickener can be used to provide increased viscosity or increased conductivity to the use compositions. Examples of polymeric thickeners for the aqueous compositions of the invention include, but are not limited to: carboxylated vinyl polymers such as polyacrylic acids and sodium salts thereof, ethoxylated cellulose, polyacrylamide thickeners, cross-linked, xanthan compositions, sodium alginate and algin products, hydroxypropyl cellulose, hydroxyethyl cellulose, and other similar aqueous thickeners that have some substantial proportion of water solubility. Examples of suitable commercially available thickeners include, but are not limited to: Acusol, available from Rohm & Haas Company, Philadelphia, Pa.; and Carbopol, available from B.F. Goodrich, Charlotte, N.C.

Examples of suitable polymeric thickeners include, but not limited to: polysaccharides. An example of a suitable commercially available polysaccharide includes, but is not limited to, Diutan, available from Kelco Division of Merck, San Diego, Calif. Thickeners for use in the cleaning compositions further include polyvinyl alcohol thickeners, such as, fully hydrolyzed (greater than 98.5 mol acetate replaced with the —OH function).

An example of a particularly suitable polysaccharide includes, but is not limited to, xanthans. Such xanthan polymers are preferred due to their high water solubility, and great thickening power. Xanthan is an extracellular polysaccharide of xanthomonas campestras. Xanthan may be made by fermentation based on corn sugar or other corn sweetener by-products. Xanthan comprises a poly beta-(1-4)-D-Glucopyranosyl backbone chain, similar to that found in cellulose. Aqueous dispersions of xanthan gum and its derivatives exhibit novel and remarkable rheological properties. Low concentrations of the gum have relatively high viscosities which permit it to be used economically. Xanthan gum solutions exhibit high pseudo plasticity, i.e. over a wide range of concentrations, rapid shear thinning occurs that is generally understood to be instantaneously reversible. Non-sheared materials have viscosities that appear to be independent of the pH and independent of temperature over wide ranges. Preferred xanthan materials include crosslinked xanthan materials. Xanthan polymers can be crosslinked with a variety of known covalent reacting crosslinking agents reactive with the hydroxyl functionality of large polysaccharide molecules and can also be crosslinked using divalent, trivalent or polyvalent metal ions. Such crosslinked xanthan gels are disclosed in U.S. Pat. No. 4,782,901, which is herein incorporated by reference. Suitable crosslinking agents for xanthan materials include, but are not limited to: metal cations such as Al+3, Fe+3, Sb+3, Zr+4 and other transition metals. Examples of suitable commercially available xanthans include, but are not limited to: KELTROL®, KELZAN® AR, KELZAN® D35, KELZAN® S, KELZAN® XZ, available from Kelco Division of Merck, San Diego, Calif. Known organic crosslinking agents can also be used. A preferred crosslinked xanthan is KELZAN® AR, which provides a pseudo plastic use composition that can produce large particle size mist or aerosol when sprayed.

Methods of Manufacture

In general, the cleaning composition of the present invention can be created by combining the alkalinity source, the surfactant, the polymer including maleic acid, vinyl acetate and ethyl acrylate segments, any secondary polymer sources, and any additional functional components and allowing the components to interact.

The alkalinity source, the surfactant, the polymer including maleic acid, vinyl acetate and ethyl acrylate segments, any secondary polymer sources, and any additional functional components can harden into solid form. The solidification process may last from a few minutes to about six hours, depending on factors including, but not limited to: the size of the formed or cast composition, the ingredients of the composition, and the temperature of the composition.

The solid cleaning compositions may be formed using a batch or continuous mixing system. In an exemplary embodiment, a single- or twin-screw extruder is used to combine and mix one or more cleaning agents at high shear to form a homogeneous mixture. In some embodiments, the processing temperature is at or below the melting temperature of the components. The processed mixture may be dispensed from the mixer by forming, casting or other suitable means, whereupon the cleaning composition hardens to a solid form. The structure of the matrix may be characterized according to its hardness, melting point, material distribution, crystal structure, and other like properties according to known methods in the art. Generally, a solid cleaning composition processed according to the method of the invention is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

By the term “solid”, it is meant that the hardened composition will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the cleaning composition under the expected conditions of storage and use of the solid cleaning composition. In general, it is expected that the cleaning composition will remain in solid form when exposed to temperatures of up to approximately 100° F. and particularly up to approximately 120° F.

The resulting solid cleaning composition may take forms including, but not limited to: a cast solid product; an extruded, molded or formed solid pellet, block, tablet, powder, granule, flake; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use composition. The solution may be directed to a storage reservoir for later use and/or dilution, or may be applied directly to a point of use.

In certain embodiments, the solid cleaning composition is provided in the form of a unit dose. A unit dose refers to a solid cleaning composition unit sized so that the entire unit is used during a single washing cycle. When the solid cleaning composition is provided as a unit dose, it is typically provided as a cast solid, an extruded pellet, or a tablet having a size of between approximately 1 gram and approximately 50 grams.

In other embodiments, the solid cleaning composition is provided in the form of a multiple-use solid, such as a block or a plurality of pellets, and can be repeatedly used to generate aqueous cleaning compositions for multiple washing cycles. In certain embodiments, the solid cleaning composition is provided as a cast solid, an extruded block, or a tablet having a mass of between approximately 5 grams and approximately 10 kilograms. In certain embodiments, a multiple-use form of the solid cleaning composition has a mass between approximately 1 kilogram and approximately 10 kilograms. In further embodiments, a multiple-use form of the solid cleaning composition has a mass of between approximately 5 kilograms and about approximately 8 kilograms. In other embodiments, a multiple-use form of the solid cleaning composition has a mass of between about approximately 5 grams and approximately 1 kilogram, or between approximately 5 grams and approximately 500 grams.

Although the cleaning composition is discussed as being formed into a solid product, the cleaning composition may also be provided in the form of a paste, liquid or gel. When the concentrate is provided in the form of a paste, liquid or gel, enough water is added to the cleaning composition such that complete solidification of the cleaning composition is precluded. The paste, liquid or gel may be provided in the form of a unit dose or multiple use composition. In addition, dispersants and other components may be incorporated into the cleaning composition in order to maintain a desired distribution of components.

Methods of Use

The cleaning compositions can include concentrate compositions or can be diluted to form use compositions. In general, a concentrate refers to a composition that is intended to be diluted with water to provide a use composition that contacts an object to provide the desired cleaning, rinsing, or the like. The cleaning composition that contacts the articles to be washed can be referred to as the use composition. The use composition can include additional functional ingredients at a level suitable for cleaning, rinsing, or the like.

A use composition may be prepared from the concentrate by diluting the concentrate with water at a dilution ratio that provides a use composition having desired detersive properties. The water that is used to dilute the concentrate to form the use composition can be referred to as water of dilution or a dilutent, and can vary from one location to another. The typical dilution factor is between approximately 1 and approximately 10,000 but will depend on factors including water hardness, the amount of soil to be removed and the like. In one embodiment, the concentrate is diluted at a ratio of between about 1:10 and about 1:1000 concentrate to water. Particularly, the concentrate is diluted at a ratio of between about 1:100 and about 1:5000 concentrate to water. More particularly, the concentrate is diluted at a ratio of between about 1:250 and 1:2000 concentrate to water.

A suitable concentration range of the components in the use composition includes between about 10 and 8,000 parts-per-million (ppm) alkalinity source, and between about 10 and 2,000 ppm of the polymer containing maleic acid, vinyl acetate and alkyl acrylate monomers. A particularly suitable concentration range of components in the use composition includes between about 100 and 6,000 ppm alkalinity source, and between about 10 and 1,000 ppm of the polymer containing the maleic acid, vinyl acetate and alkyl acrylate monomers. A more particularly suitable concentration range of components in the use composition includes between about 250 and 4,000 ppm alkalinity source, and between about 10 and 500 ppm of the polymer containing the maleic acid, vinyl acetate and alkyl acrylate monomers.

Where the cleaning composition includes secondary polymer sources, a suitable concentration range of the components in the use composition includes between about 10 and 8,000 ppm alkalinity source, and between about 10 and 2,000 ppm of the polymer (which includes at least the polymer containing maleic acid, vinyl acetate and alkyl acrylate monomers and at least one secondary polymer source).

The use composition can be used at elevated temperature. In one example, the use composition is used at temperature between approximately 70° F. and approximately 150° F. to contact the substrate to be cleaned. In another example, the use composition is used at a temperature between approximately 100° F. and approximately 120° F. to contact the substrate to be cleaned.

The use composition contains an effective concentration of the alkalinity source so that the use composition has a pH of between about 7 and about 11.5.

The use composition can be brought into contact with soiled articles to clean the articles. The maleic acid, vinyl acetate and ethyl acrylate polymer of the use composition may function as a scale inhibitor.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

Materials Used

Alcosperse® 125: a methacrylate polymer available from Akzo Nobel Surfactants, Chicago, Ill.

Belclene® 283: a maleic acid, ethyl acrylate and vinyl acetate terpolymer available from BWA Water Additives, Tucker, Ga.

Belclene® 810: a maleic acid, ethyl acrylate and vinyl acetate terpolymer available from BWA Water Additives, Tucker, Ga.

Acusol® 445N: a polyacrylate homopolymer available from Rohm and Haas, Philadelphia, Pa.

5 Cycle Automatic Dishwashing Test

All automatic dishwashing experiments were performed using a Maytag Jetclean, portable tall tub consumer dishwasher (Model # MDC4809AWB) operating in the normal cycle without heated drying. The 17 grain water used for all experiments was preheated with a booster heater prior to entering the machine to ensure uniform temperature throughout all experiments (135-140° F.). To determine the ability of various cleaning compositions to prevent hard water scale accumulation, 5 Libbey glasses were prepared by removing all film and foreign material from the surfaces of the glasses. The 5 Libbey glasses were placed in the top rack of the dishwasher arranged with one glass in the center of the rack and the remaining four in each corner (X pattern). The appropriate amount of detergent was placed in the detergent dispenser and the lid was placed in the closed position. The dishwasher was then started using the normal cycle without heated drying.

Four additional cycles were completed (without drying in between each cycle) with the appropriate amount of detergent added in between each cycle. Upon completion of 5 cycles, the glasses were removed from the dishwasher and allowed to dry overnight. The glassed were then graded using the lightbox evaluation test

Light Box Evaluation Test

The light box test standardizes the evaluation of the glasses run on the 5 cycle dishwashing test using an analytical method. The light box test is based on the use of an optical system including a photographic camera, a lightbox, a light source and a light meter. The system is controlled by a computer program (Spot Advance and Image Pro Plus).

To evaluate the glasses, each glass was placed on the light box resting on its side and the intensity of the light source was adjusted to a predetermined value using a light meter. The conditions of the 5 cycle dishwashing test were entered into the computer. A picture of the glass was taken with the camera and saved on the computer for analysis by the program. The picture was analyzed using the upper half of the glass in order to avoid the gradient of darkness on the film from the top of the glass to the bottom of the glass, based on the shape of the glass. Generally, a lower light box rating indicates that more light was able to pass through the glass. Thus, the lower the light box rating, the more effective the cleaning composition was at preventing scale on the surface of the glass.

Control #1 and Examples #1 and #2

The raw materials identified for each of Control #1 and Examples #1 and #2 in Table 1 below were combined and mixed to form concentrate cleaning compositions.

TABLE 1

| 30 g of Composition | Control #1 | Example #1 | Example #2 |
|---|---|---|---|
| Sodium Carbonate | 84 | 84 | 84 |
| (Alkalinity Source) | | | |
| Belclene 810 | 0 | 2 | 0 |
| (Terpolymer Source) | | | |
| Belclene 283 | 0 | 0 | 2.1 |
| (Terpolymer Source) | | | |
| Alcosperse 125 | 0 | 0 | 0 |
| (Polymethacrylate) | | | |
| Sodium Sulfate | 16 | 14 | 13.9 |
| (Filler) | | | |

A warewash test was conducted with the compositions of Control 1 and Examples 1 and 2 according to the 5 cycle dishwashing test described above. The results of the light box test are presented below in Table 2.

For Control 1 and Examples 1 and 2, the alkalinity source was held constant and no additional polymer sources were added. Control 1 didn't include a terpolymer source, while Example 1 used Belclene 810 as a polymer source and Example 2 used Belclene 283 as a terpolymer source. The purpose of this test was to determine if adding a terpolymer to a cleaning composition is effective in preventing scale formation on the surface of the glass.

TABLE 2

| | Sum of Light Box Scores (6 glasses) |
|---|---|
| Control 1 | 226707 |
| Example 1 | 194964 |
| Example 2 | 106430 |

As can be seen from the light box scores in Table 2, Examples 1 and 2 have lower light box scores which mean that more light passed through the glass and so it was conclusive that addition of a terpolymer to a cleaning composition is effective in preventing scale formation on the surface of the glass.

Control #2 and Examples #3 and #4

The raw materials identified for each of Control #2 and Examples #3 and #4 in Table 3 below were combined and mixed to form concentrate cleaning compositions.

TABLE 3

| 78 g of Composition | Control #2 | Example #3 | Example #4 |
|---|---|---|---|
| Sodium Carbonate | 84 | 84 | 84 |
| (Alkalinity Source) | | | |
| Belclene 810 | 0 | 2 | 0 |
| (Terpolymer Source) | | | |
| Belclene 283 | 0 | 0 | 2.1 |
| (Terpolymer Source) | | | |
| Alcosperse 125 | 0 | 0 | 0 |
| (Polymethacrylate) | | | |
| Sodium Sulfate | 16 | 14 | 13.9 |
| (Filler) | | | |

For Control 2 and Examples 3 and 4, the raw materials of the cleaning compositions are identical to Control 1 and Examples 1 and 2, but 78 grams of the cleaning composition were used instead of 30 grams. Generally, the ability to prevent scale formulation is hard in cleaning compositions with a higher alkalinity concentration. The purpose of this test was to determine if adding a terpolymer to a cleaning composition with a higher alkalinity concentration is effective in preventing scale formation on the surface of the glass.

A warewash test was conducted with the compositions of Control 2 and Examples 3 and 4 according to the 5 cycle dishwashing test described above. The results of the light box test are presented below in Table 4.

TABLE 4

| | Sum of Light Box Scores (6 glasses) |
|---|---|
| Control 2 | 237714 |
| Example 3 | 203535 |
| Example 4 | 108206 |

As can be seen from the light box scores in Table 4, Examples 3 and 4 have lower light box scores which mean that more light passed through the glass and so it was conclusive that addition of a terpolymer to a cleaning composition with a higher alkalinity concentration is effective in preventing scale formation on the surface of the glass.

Control #3 and Examples #5, #6, #7 and #8

The raw materials identified for each of Control #3 and Examples #5, #6, #7 and #8 in Table 5 below were combined and mixed to form concentrate cleaning compositions. The Belclene 810 Premix is a source of a terpolymer and includes 71.4% Beleclene 810 and 28.6% of a caustic such as sodium hydroxide, which helps in neutralizing the terpolymer source.

TABLE 5

| | | | | Exam- | Exam- |
|---|---|---|---|---|---|
| | Control | Example | Example | ple | ple |
| | #3 | #5 | #6 | #7 | #8 |
| Sodium Carbonate | 30 | 30 | 30 | 30 | 30 |
| (Alkalinity Source) | | | | | |
| Water | 10 | 0 | 0 | 0 | 0 |
| Sodium Citrate | 3 | 3 | 3 | 3 | 3 |
| (Builder) | | | | | |
| Belclene 810 | 0 | 8.4 | 5.6 | 4.2 | 2.8 |
| Premix | | | | | |
| (Terpolymer | | | | | |
| Source) | | | | | |
| Alcosperse 125 | 0 | 0 | 3.4 | 5 | 6.7 |
| (Polymethacrylate) | | | | | |
| Sodium Disilicate | 10 | 10 | 10 | 10 | 10 |
| Sodium Sulfate | 47 | 48.6 | 48 | 47.8 | 47.5 |
| (Filler) | | | | | |

The detergent formula for Control 3 did not include any additional polymer source, while the detergent formula for Example included a terpolymer source and Examples 6-8 included both a terpolymer source and a secondary polymer source, specifically a polyacrylate. The detergent formula for Example 6 included a greater percentage of the terpolymer source than the secondary polymer source, whereas the detergent formula for Example 7 included relatively equal amounts of both polymers, and the detergent formula for Example 8 included a greater percentage of the secondary polymer relative to the terpolymer source. The purpose of these examples was to determine if adding a secondary polymer source, specifically a polyacylate or a synthetic polymer, was effective in preventing scale formulation on the surface of the glass.

A warewash test was conducted with the compositions of Control 3 and Examples 5-8 according to the 5 cycle dishwashing test described above. The results of the light box test are presented below in Table 6.

TABLE 6

| | Sum of Light Box Scores (6 glasses) |
|---|---|
| Control 3 | 281783 |
| Example 5 | 109871 |
| Example 6 | 113738 |
| Example 7 | 113154 |
| Example 8 | 111447 |

As can be seen from the light box scores in Table 6, Examples 5-8 have lower light box scores than Control 3 which means that more light passed through the glass and so it was conclusive that the addition of a terpolymer or the combination of a terpolymer with a secondary synthetic polymer source is effective in preventing scale formation on the surface of the glass.

Control #3 and Examples #9, #10, #11 and #12

The raw materials identified for each of Control #3 and Examples 9-12 in Table 7 below were combined and mixed to form concentrate cleaning compositions.

TABLE 7

| | Control | Example | Example | Example | Example |
|---|---|---|---|---|---|
| | #3 | #9 | #10 | #11 | #12 |
| Sodium | 30 | 30 | 30 | 30 | 30 |
| Carbonate | | | | | |
| (Alkalinity | | | | | |
| Source) | | | | | |
| Water | 10 | 0 | 0 | 0 | 0 |
| Sodium Citrate | 3 | 3 | 3 | 3 | 3 |
| (Builder) | | | | | |
| Belclene 810 | 0 | 16.8 | 11.2 | 5.6 | 0 |
| Premix | | | | | |
| (Terpolymer) | | | | | |
| Acusol 445N | 0 | 4.4 | 8.9 | 13.3 | 17.8 |
| (Polyacrylate) | | | | | |
| Sodium | 10 | 10 | 10 | 10 | 10 |
| Disilicate | | | | | |
| Sodium Sulfate | 47 | 35.8 | 36.9 | 38.1 | 30.3 |
| (Filler) | | | | | |

For Examples 9-12, the same control was used as in Examples 8-10. However, in Examples 9-12 a different synthetic polymer was used in the detergent formulations, specifically Acusol 445N which is a secondary polyacrylate source.

A warewash test was conducted with the compositions of Control 3 and Examples 9-12 according to the 5 cycle dishwashing test described above. The results of the light box test are presented below in Table 8.

TABLE 8

| | Sum of Light Box Scores (6 glasses) |
|---|---|
| Control 3 | 281783 |
| Example 9 | 105699 |
| Example 10 | 110714 |
| Example 11 | 117362 |
| Example 12 | 103478 |

As can be seen from the low light box scores in Examples 9-12 of Table 8, Acusol 445N as a secondary synthetic polymer source is very effective in preventing scale formulation on the surface of the glasses.

Control #3 and Examples #13, #14, #15 and #16

The raw materials identified for each of Control #3 and Examples 13-16 in Table 9 below were combined and mixed to form concentrate cleaning compositions.

TABLE 9

| | Control | Example | Example | Example | Example |
|---|---|---|---|---|---|
| | #3 | #13 | #14 | #15 | #16 |
| Sodium | 30 | 30 | 30 | 30 | 30 |
| Carbonate | | | | | |
| (Alkalinity | | | | | |
| Source) | | | | | |
| Water | 10 | 0 | 0 | 0 | 0 |
| Sodium Citrate | 3 | 3 | 3 | 3 | 3 |
| (Builder) | | | | | |
| Belclene 810 | 0 | 22.4 | 16.8 | 11.2 | 5.6 |
| Premix | | | | | |
| (Terpolymer) | | | | | |
| Acusol 445N | 0 | 0 | 6.7 | 13.3 | 20 |
| (Polyacrylate) | | | | | |
| Sodium | 10 | 10 | 10 | 10 | 10 |
| Disilicate | | | | | |
| Sodium Sulfate | 47 | 34.6 | 33.5 | 32.5 | 31.4 |
| (Filler) | | | | | |

For Examples 13-16, the same control was used as in Examples 8-10. Moreover, the detergent formulations used in Examples 13-16 are very similar to the detergent formulations in Examples 8-10, except that the formulations in Examples 13-16 include higher concentrations of the biodegradable terpolymer source. The purpose of these tests was to determine if a higher concentration of the biodegradable terpolymer source makes the detergent formulation more effective in preventing scale formulation on the glasses.

A warewash test was conducted with the compositions of Control 3 and Examples 13-16 according to the 5 cycle dishwashing test described above. The results of the light box test are presented below in Table 10.

TABLE 10

| | Sum of Light Box Scores (6 glasses) |
|---|---|
| Control 3 | 281783 |
| Example 13 | 98043 |
| Example 14 | 105005 |
| Example 15 | 101838 |
| Example 16 | 103205 |

As can be seen from the low light box scores in Examples 13-16 of Table 10, the addition of a higher concentration of the biodegradable terpolymer source mixed with a secondary synthetic polymer source makes the detergent formulation very effective in preventing scale formulation on the glasses.

Various modifications and additions can be made to the exemplary embodiments discussed without departing from the scope of the present invention. For example, while the embodiments described above refer to particular features, the scope of this invention also include embodiments having different combinations of features and embodiments that do not include all of the above described features.

The following is claimed:

1. A cleaning composition for preventing scale accumulation on various surfaces, the cleaning composition comprising:
an alkalinity source in an amount of between approximately 10% and approximately 90% by weight of the cleaning composition, wherein the alkalinity source is selected from the group consisting of alkali metal carbonate, alkali metal silicate, or combinations thereof and wherein the concentration of alkali metal carbonate by weight is greater than the concentration of alkali metal silicate; and
a polymer comprising maleic acid, vinyl acetate and alkyl acrylate monomers, the polymer in an amount equal to or greater than about 0.1% by weight of the cleaning composition.

2. The cleaning composition of claim 1, wherein the polymer is in an amount less than about 20% by weight of the cleaning composition.

3. The cleaning composition of claim 1, further comprising a polycarboxylic acid.

4. The cleaning composition of claim 3, wherein the polycarboxylic acid is selected from the group consisting of polyacrylic acid, polymethacrylic acid, polymaleic acid homopolymers, copolymer of acrylic acid, copolymer of methacrylic acid, copolymer of maleic acid, acrylic acid, methacrylic acid, maleic acid terpolymers, or combinations thereof.

5. The cleaning composition of claim 1, wherein the cleaning composition further comprises less than 5% by weight sodium disilicate, alkali metal hydroxide, alkali metal metasilicate, or combinations thereof.

6. The cleaning composition of claim 1, wherein the cleaning composition further comprises a builder.

7. The cleaning composition of claim 1, wherein the cleaning composition further comprises a metal protector.

8. The cleaning composition of claim 1, wherein the cleaning composition comprises less than about 0.5% phosphorus by weight.

9. The cleaning composition of claim 1, wherein the cleaning composition further comprises a surfactant.

10. The cleaning composition of claim 1, wherein the polymer is biodegradable.

11. The cleaning composition of claim 1, wherein the polymer is a non-saccharide.

12. The cleaning composition of claim 1, wherein the polymer is a terpolymer.

13. The cleaning composition of claim 13, wherein the terpolymer has molecular weight between about 500 g/mol and about 5,000 g/mol.

14. The cleaning composition of claim 1, wherein the terpolymer comprises:
i. the monomer of maleic acid in an amount of between approximately 40% and approximately 99% by weight of the terpolymer;
ii. the vinyl acetate monomer in an amount of between approximately 1% and approximately 50% by weight of the terpolymer; and
iii. the alkyl acrylate monomer in an amount of between approximately 1% and approximately 50% by weight of the terpolymer.

15. The cleaning composition of claim 1, wherein the alkyl acrylate monomer is selected from the group consisting of methyl acrylate, ethyl acrylate, propyl acrylate, butyl acrylate, isopropyl acrylate and tert-butyl acrylate.

16. The cleaning composition of claim 1, wherein the vinyl acetate and alkyl acrylate monomers include at least one hydrolyzed vinyl acetate or alkyl acrylate monomer.

17. The cleaning composition of claim 1, wherein the cleaning composition is in the form of a solid block, powder, tablet, liquid, gel or paste.

18. A method of preventing scale accumulation during a wash cycle, the method comprising:
i. diluting a detergent composition with water at a dilution ratio of between about 1:10 and about 1:10,000 to form a use solution, the detergent composition comprising an alkalinity source, a surfactant system and a polymer comprising maleic acid, vinyl acetate and alkyl acrylate monomers; and
ii. contacting the use solution with a substrate to be cleaned;
iii. wherein a temperature of the wash cycle is between about 70 degrees and 150 degrees Fahrenheit;
iv. wherein the alkalinity source is in an amount of between approximately 10% and approximately 90% by weight of the detergent composition;
v. wherein the polymer is in an amount equal to or greater than about 0.1% by weight of the detergent composition;
vi. wherein the use solution has a pH of between about 7 and about 11.5.

19. The method of claim 18, wherein the alkalinity source is selected from the group consisting of alkali metal carbonate, alkali metal silicate, or combinations thereof.

20. The method of claim 18, wherein the detergent composition further comprises less than 5% by weight sodium disilicate, alkali metal hydroxide, alkali metal metasilicate, or combinations thereof.

21. The method of claim 18, wherein the detergent composition further comprises a builder.

22. The method of claim 18, wherein the detergent composition further comprises a metal protector.

23. The method of claim 18, wherein the detergent composition comprises less than about 0.5% phosphorus by weight.

24. The method of claim 18, further comprising casting the detergent composition into a solid block prior to diluting the detergent composition.

25. The method of claim 18, wherein applying the use solution to a substrate comprises applying the use solution to glass, metal, ceramic, or plastic.

26. The method of claim 18, further comprising mixing a polycarboxylic acid to the detergent composition.

27. The method of claim 26, wherein the polycarboxylic acid is selected from the group consisting of polyacrylic acid, polymethacrylic acid, polymaleic acid homopolymers, copolymer of acrylic acid, copolymer of methacrylic acid, copolymer of maleic acid, acrylic acid, methacrylic acid, maleic acid terpolymers, or combinations thereof.

28. The method of claim 18, wherein the polymer is biodegradable.

29. The method of claim 18, wherein the polymer is a non-saccharide.

30. The method of claim 18, wherein the polymer is a terpolymer.

31. The method of claim 30, wherein the terpolymer has molecular weight between about 500 g/mol and about 5,000 g/mol.

32. The method of claim 18, wherein the terpolymer comprises:
i. the monomer of maleic acid in an amount of between approximately 40% and approximately 99% by weight of the terpolymer;
ii. the vinyl acetate monomer in an amount of between approximately 1% and approximately 50% by weight of the terpolymer; and
iii. the alkyl acrylate monomer in an amount of between approximately 1% and approximately 50% by weight of the terpolymer.

33. The method of claim 18, wherein the alkyl acrylate monomer is selected from the group consisting of methyl acrylate, ethyl acrylate, propyl acrylate, butyl acrylate, isopropyl acrylate and tert-butyl acrylate.

34. The method of claim 18, wherein the vinyl acetate and alkyl acrylate monomers include at least one hydrolyzed vinyl acetate or alkyl acrylate monomer.

35. A detergent composition for preventing scale accumulation on various surfaces, the detergent composition comprising:
i. an alkalinity source in an amount of between approximately 10% and approximately 90% by weight of the cleaning composition, wherein the alkalinity source is selected from the group consisting of alkali metal carbonate, alkali metal silicate, or combinations thereof and wherein the concentration of alkali metal carbonate by weight is greater than the concentration of alkali metal silicate;
ii. a polymer comprising maleic acid, vinyl acetate and alkyl acrylate monomers, the polymer in an amount equal to or greater than about 0.1% by weight of the detergent composition;
iii. a co-polymer comprising a polycarboxylic acid in an amount equal to or greater than about 0.1% by weight of the detergent composition, wherein the polycarboxylic acid is selected from the group consisting of polyacrylic acid, polymethacrylic acid, polymaleic acid homopolymers, copolymer of acrylic acid, copolymer of methacrylic acid, copolymer of maleic acid, acrylic acid, methacrylic acid, maleic acid terpolymers, or combinations thereof; and
iv. a surfactant system.

36. The detergent composition of claim 35, wherein the detergent composition further comprises less than 5% by weight sodium bisilicate, alkali metal hydroxide, alkali metal metasilicate or combinations thereof.

37. The detergent composition of claim 35, wherein the detergent composition further comprises a builder.

38. The detergent composition of claim 35, wherein the detergent composition further comprises a metal protector.

39. The detergent composition of claim 35, wherein the detergent composition comprises less than about 0.5% phosphorus by weight.

40. The detergent composition of claim 35, wherein the polymer is biodegradable.

41. The detergent composition of claim 35, wherein the polymer is a non-saccharide.

42. The detergent composition of claim 35, wherein the polymer is a terpolymer.

43. The detergent composition of claim 42, wherein the terpolymer has molecular weight between about 500 g/mol and about 5,000 g/mol.

44. The detergent composition of claim 35, wherein the terpolymer comprises:
i. the monomer of maleic acid in an amount of between approximately 40% and approximately 99% by weight of the terpolymer;
ii. the vinyl acetate monomer in an amount of between approximately 1% and approximately 50% by weight of the terpolymer; and
iii. the alkyl acrylate monomer in an amount of between approximately 1% and approximately 50% by weight of the terpolymer.

45. The detergent composition of claim 35, wherein the alkyl acrylate monomer is selected from the group consisting of methyl acrylate, ethyl acrylate, propyl acrylate, butyl acrylate, isopropyl acrylate and tert-butyl acrylate.

46. The detergent composition of claim 35, wherein the vinyl acetate and alkyl acrylate monomers include at least one hydrolyzed vinyl acetate or alkyl acrylate monomer.

47. The detergent composition of claim 35, wherein the detergent composition is in the form of a solid block, powder, tablet, liquid, gel or paste.
